(19) United States
(12) Patent Application Publication
(10) Pub. No.: US 2014/0000731 A1
(43) Pub. Date: Jan. 2, 2014

(54) Flow Control Valve Assemblies with Check Valves

(71) Applicants: George J. Sciuto, St. Louis, MO (US); Christian J. Mutschler, Ellisville, MO (US)

(72) Inventors: George J. Sciuto, St. Louis, MO (US); Christian J. Mutschler, Ellisville, MO (US)

(73) Assignee: Emerson Electric Co., St. Louis, MO (US)

(21) Appl. No.: 13/537,782

(22) Filed: Jun. 29, 2012

(51) Int. Cl. F16K 1/34; G05D 7/03; F16K 15/02

(52) U.S. Cl. 137/528; 251/368; 137/613

(57) ABSTRACT

According to various aspects, exemplary embodiments are disclosed of check valves and fluid control valve assemblies including the same. In an exemplary embodiment, a valve assembly generally includes a valve housing including a check valve chamber and an opening. The valve assembly further includes a check valve for controlling fluid flow relative to the check valve chamber. A plug is sealingly engaged within the opening, to thereby seal the check valve chamber and restrict fluid flow from the check valve chamber out the opening through the valve housing. A flux-coated solder ring may be along an outer surface of the plug, without any flux-coated solder ring along an inner surface of the plug.

### FIELD

The present disclosure relates to flow control valve assemblies with check valves.

### BACKGROUND

The statements in this section merely provide background information related to the present disclosure and may not constitute prior art.

Flow control valves are typically utilized to control the flow of working fluids in various systems such as a refrigeration system or heating, ventilation, and air conditioning (HVAC) system. In operation, a flow control valve regulates the flow or pressure of the working fluid.

A flow control valve assembly may include a check valve that allows fluid to flow through the check valve in only one direction. The check valve typically includes a valve member movable relative to a valve port or opening between open and closed positions. In the closed position, the valve member contacts a valve seat to thereby obstruct the valve port and prevent fluid flow through the valve port. But in the open position, the valve member is spaced apart and/or not seated against the valve seat such that fluid flow is permitted through the valve port.

### SUMMARY

This section provides a general summary of the disclosure, and is not a comprehensive disclosure of its full scope or all of its features.

According to various aspects, exemplary embodiments are disclosed of check valves and fluid control valve assemblies including the same. In an exemplary embodiment, a valve assembly generally includes a valve housing including a check valve chamber and an opening. The valve assembly further includes a check valve for controlling fluid flow relative to the check valve chamber. A plug is sealingly engaged within the opening, to thereby seal the check valve chamber and restrict fluid flow from the check valve chamber out the opening through the valve housing. A flux-coated solder ring may be along an outer surface of the plug, without any flux-coated solder ring along an inner surface of the plug.

Another exemplary embodiment includes a check valve including a plate that is sealingly engageable with a valve opening. The check valve includes a central projection extending outwardly from the plate. The central projection is configured for contacting an external component to inhibit contact of the plate with the external component to thereby reduce surface area contact between the check valve and the external component. The check valve also includes a portion extending outwardly from the plate in a direction opposite of the central projection. The portion is configured to be slidably disposed within the valve opening, whereby the plate is slidably movable between open and closed positions relative to the valve opening.

In another exemplary embodiment, a valve assembly includes a valve housing having a check valve chamber. A first valve opening is between an inlet and an outlet. A second valve opening is between the outlet and the check valve chamber. A control valve element is movable relative to the first valve opening for opening and closing the first valve opening. The valve assembly also includes a check valve member comprising injection molded polyether ether ketone. The check valve member is movable relative to the second valve opening between an open position in which fluid flow is permitted through the second valve opening and a closed position in which the check valve member restricts fluid flow through the second valve opening.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a partial cross-sectional perspective view of an exemplary embodiment of a flow control valve assembly having a check valve in accordance with principles of the present disclosure;

FIG. 2 is a cross-sectional view of the exemplary embodiment of the check valve shown in FIG. 1, and also illustrating an exemplary plug or cover having a flux-coated solder ring only on the outside of the plug in accordance with principles of the present disclosure;

FIG. 3 is a partial cross-sectional view of another exemplary embodiment of a flow control valve assembly having a check valve in accordance with principles of the present disclosure, where the check valve is shown in a closed position;

FIG. 4 is another cross-sectional view of the flow control valve assembly shown in FIG. 3, where the check valve is shown in an open position;

FIG. 5 is a cross-sectional view of the portion of the flow control valve assembly designated in FIG. 3; and

FIG. 6 is a perspective view of an exemplary embodiment of the movable valve member shown in FIGS. 3 through 5.

Corresponding reference numerals indicate corresponding parts throughout the several views of the drawings.

### DETAILED DESCRIPTION

Example embodiments will now be described more fully with reference to the accompanying drawings.

The inventors hereof have recognized the following issues with conventional check valves that may cause the check valve to become stuck while in use in the field. For example, the inventors have discovered the movable valve member or element of a conventional check valve when open may adhere to the plug that is used to seal the check valve chamber due to excess or over application of flux. This excess flux may arise from having a flux-coated solder ring on the inside of the plug, as some conventional check valves have solder rings along both sides of the plug and liquid flux applied to both sides of the plug. Flux in the trepan and/or flux on the legs of the valve member may also foster sticking of the valve member as it slides along the trepan between the open and closed positions.

The inventors have also discovered that the movable valve member of a conventional check valve may get stuck or wedged in the trepan. For example, the valve member may lean over in the open position when the system is off and there is an insufficient or no pressure differential to close the valve. As another example, a movable member may wedge itself in the trepan as it is closing when the system or pressure is turned on in the forward direction. Also, some conventional check valve members include steel legs that may have sharp burrs on the outside of the legs, which may bite into a softer brass valve body causing the valve member to become stuck and prevent proper movement of the valve member.

After recognizing the above problems, the inventors hereof developed and disclose herein exemplary embodiments of check valves having improved functionality as compared to some conventional check valves. The inventors have disclosed exemplary embodiments of check valves configured (e.g., differently shaped, formed of different materials and/or manufacturing processes, etc.) to avoid problems associated with the valve member becoming wedged and/or stuck, e.g., due to excess or over application of flux, burrs on the legs of the check valve member, and/or too much allowable surface contact area between the movable valve member and the plug (inadequate non-stiction features).

In some exemplary embodiments, a check valves includes a valve member with burrs removed from its legs via a tumbling process. In some exemplary embodiments, a flux-coated solder ring (e.g., for sealing and/or rollover for joint strength, etc.) is along only the outside of the plug without any solder ring or liquid flux applied to the inside of the plug.

In some exemplary embodiments, a valve member comprises a member (e.g., poppet, generally mushroom shaped member, etc.) formed via injection molding and/or formed from polymer or other non-metal. By way of example, the valve member may comprise polyether ether ketone (PEEK) filled with polytetrafluoroethylene (PTFE), such as PEEK with 20% PTFE, etc. In such embodiments, the injection molded PEEK valve member may replace a conventional stamped metal valve member, such that better lubricity is provided and/or burrs are eliminated. Also, the valve member may be configured such that it rides or slides along the internal bore or chamber of the check valve instead of a trepan, thereby allowing elimination of the trepan. The valve member may include one or more legs or guide members configured with only one sliding surface that contacts and/or slides along the internal bore or chamber as the valve member is moved between its open and closed positions. The valve member may further include a stop (e.g., a central projection, etc.) that contacts the plug to restrict further movement of the valve member towards the plug when being opened, thereby reducing the stiction and surface area contact between the valve member and plug.

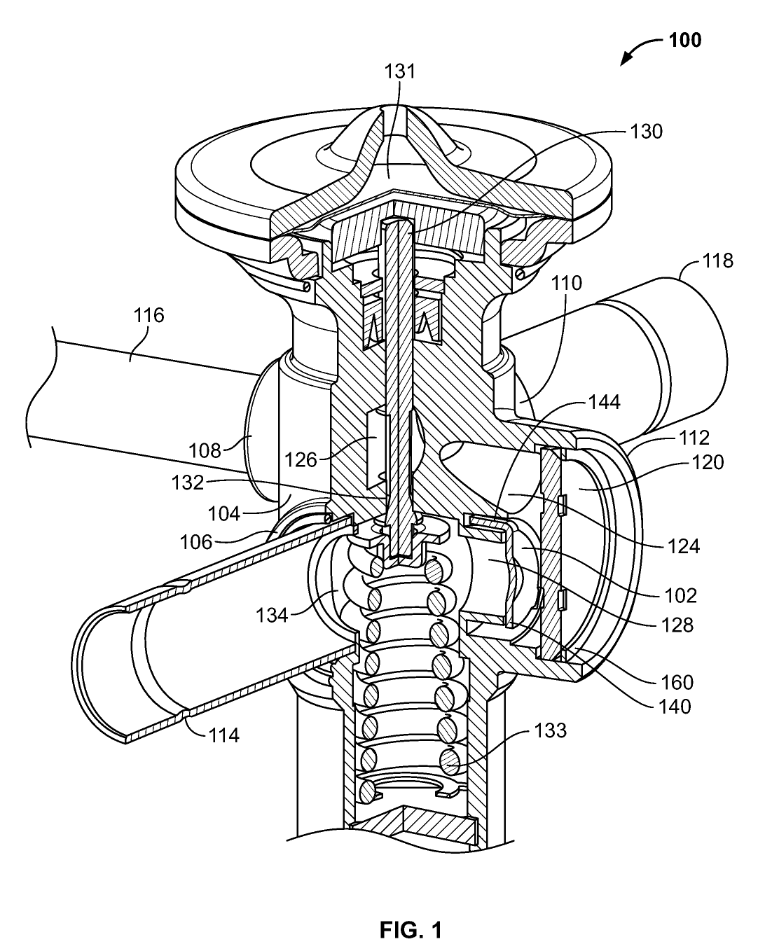

With reference now to the figures, FIG. 1 illustrates an exemplary embodiment of a flow control valve assembly 100 having a check valve 102 embodying one or more aspects of the present disclosure. In operation, the flow control valve assembly 100 is operable for controlling multidirectional (e.g., bidirectional, etc.) fluid flow through the valve assembly 100. The check valve 102 inhibits or prevents fluid flow therethrough when closed but allows fluid flow therethrough when open.

As shown in FIG. 1, the flow control valve assembly 100 includes a valve housing or body 104 and a plurality of valve ports or openings 106, 108, 110, and 112. The valve assembly 100 is connected at its ports 106, 108, 110 to pipes or other fluid conduits 114, 116, 118, respectively, for conveying fluids to/from the valve assembly 100. Accordingly, the valve ports 106, 108, 110 and pipes 114, 116, 118 define or provide inlets and/or outlets for fluid flow through the valve assembly 100.

The valve port 112 is not connected to a fluid conduit. Instead, the valve port 112 is sealed or closed off by a plug or cover 120, which is described in more detail herein.

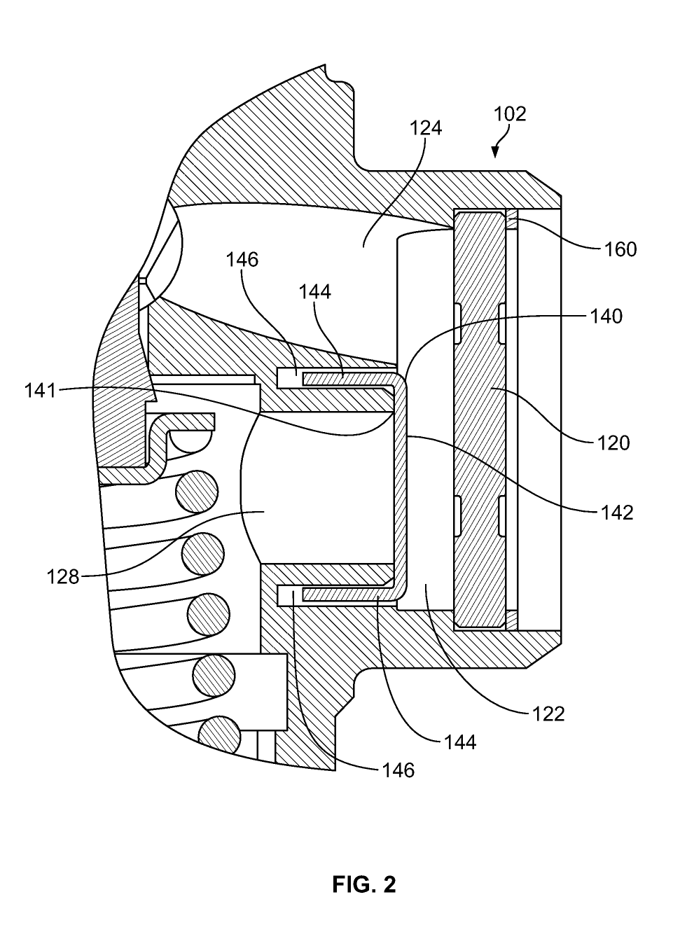

The valve assembly 100 also includes a check valve chamber 122 (FIG. 2) in fluid communication with the opening or valve port 112, which extends through a side of the valve housing 104. The valve port 112 is sealed or closed off by a plug 120, such that fluid from the check valve chamber 122 is prevented from flowing out the valve port 112.

A passageway 124 extends between the check valve chamber 122 and another valve chamber 126, which is in fluid communication with the valve ports 108, 110. Accordingly, fluid may flow between the chambers 122 and 126 via the passageway 124 when the check valve 102 is open.

A valve opening or passageway 128 is between the valve port or opening 106 and the check valve chamber 122. Accordingly, fluid may flow between the check valve chamber 122 and the valve port 106 (and pipe 114 connected thereto) when the check valve 102 is open.

In addition to the check valve 102, the valve assembly 100 also includes a control valve member or element 130. The control valve element 130 is movable (e.g., by a diaphragm 131, coil spring 133, etc.) relative to a valve opening or passageway 132 for opening and closing the valve opening 132, which extends between the valve inlet chamber 126 and a valve outlet chamber 134. The control valve element 130 is operable for regulating fluid flow through the opening 132 when fluid flow is in the inlet-to-outlet direction, such as would typically occur during normal air conditioner operation. The control valve 130 is movable to sealingly engage or block the opening 132 to restrict fluid flow when fluid flow is in the outlet-to-inlet direction, such that fluid flow in a reverse direction through the opening 132 is prevented or at least inhibited.

The check valve 102 includes a check valve member 140 movable between a closed position (shown in FIG. 2) and an open position, which movement may be generally perpendicular to the valve opening 128. In the closed position, the valve member 140 sealingly engages or blocks the valve opening or passageway 128, such that the valve member 140 prevents or at least inhibits fluid flow, e.g., in a forward or inlet-to-outlet direction, from the check valve chamber 122 to the valve opening 128. From the closed position, the valve member 140 is movable away from the valve seat 141 to the open position. In the open position, the valve member 140 is spaced apart from the valve seat or portion 141 such that fluid flow, e.g., in a reverse or outlet-to-inlet direction, is permitted from the valve opening 128 to the check valve chamber 122.

The check valve member 140 comprises a first or sealing member 142 and at least one second or guide member 144 extending outwardly from the first member 142. The first member 142 is configured to contact the valve seat 141 and seal or close the valve opening 128 when in the closed position. The at least one second member 144 is configured to ride, slide, and/or engage within one or more grooves or slots 146 (e.g., a trepan, etc.) of the check valve 102 as the valve member 140 is moved between its open and closed positions. The one or more grooves or slots 146 are disposed outside of or along a perimeter of the valve opening 128.

In this illustrated embodiment, the first member 142 comprises a generally flat, circular plate. The at least one second member 144 comprises a plurality of legs that extend outwardly from the first member or plate 142. The check valve 140 may comprise stamped metal such that there are three legs integrally formed with and circumferentially, equally spaced about a perimeter edge of the plate 142. A tumbling process may be performed on the legs to remove burrs that might otherwise prevent proper movement of the check valve 140 and cause the check valve 140 to become stuck if the burrs should bite into the material forming the one or more grooves, slots, or trepan 146 in which the legs slide. Accordingly, removing the burrs on the legs of the check valve via a tumbling process may help improve functionality of the check valve 102.

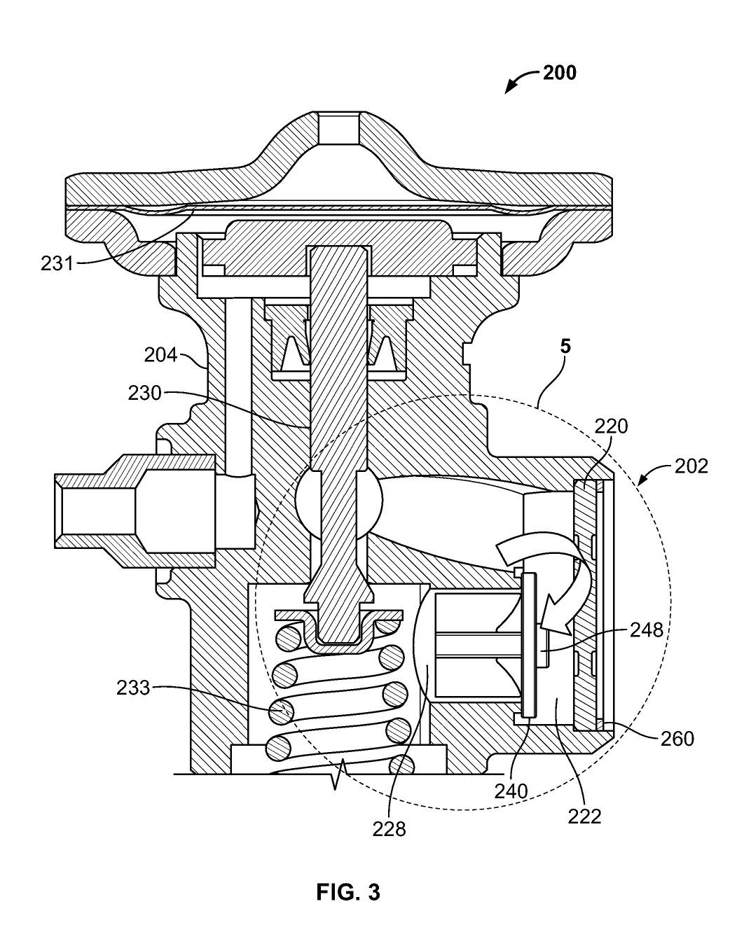

In alternative embodiments, the check valve 140 may have a different configuration (e.g., different shape, non-integral legs attached to the plate, etc.). The check valve 140 may be formed from different materials (e.g., PEEK, PEEK filled with PTFE, etc.) and/or manufacturing processes (e.g., injection molding, etc.). For example, and as disclosed below, FIGS. 3 through 6 illustrate another exemplary embodiment of a check valve member 240 that is injection molded from PEEK or PEEK filled with PTFE (e.g., PEEK with 20 percent PTFE loading, etc.) and that includes a central projection 248 (broadly, a stop) extending or projecting outwardly from a plate member.

With continued reference to FIG. 2, the flow control valve assembly 100 further includes the plug or cover 120, which is disposed and secured within the valve port or opening 112. The plug 120 seals or closes off the valve port or opening 112 and check valve chamber 122. In operation, the plug 120 prevents, restricts, or at least inhibits fluid from leaking or escaping from the check valve chamber 122 through the valve port 112.

FIG. 2 also illustrates a single solder ring 160 installed or disposed along or on an outer surface of the plug 120. The solder ring 160 is configured for helping secure the plug 120, improve sealing and/or rollover for joint strength. The solder ring 160 is coated with flux. Accordingly, this exemplary embodiment includes a flux-coated solder ring 160 only on the outside of the plug 120 without any solder ring or liquid flux applied to the inside of the plug 120. This is unlike some conventional check valves in which flux-coated solder rings are used on both the inside and the outside of the plug. As noted above, the inventors hereof have discovered that excess flux having a flux-coated solder ring on the inside of the plug may cause a check valve member to stick or adhere to a plug when the check valve is open. Accordingly, the inventors' elimination of a flux-coated solder ring on the inside of the plug 120 helps to eliminate or at least reduce problems associated with excess flux.

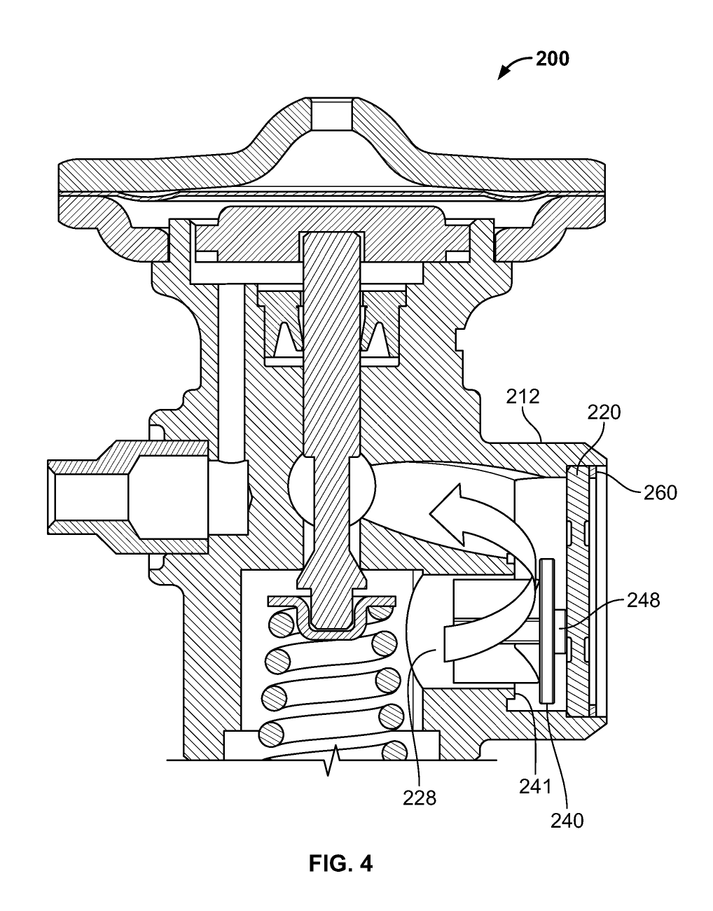

FIGS. 3 and 4 illustrate another exemplary embodiment of a flow control valve assembly 200 having a check valve 202 embodying one or more aspects of the present disclosure. In operation, the flow control valve assembly 200 is operable for controlling multidirectional (e.g., bidirectional, etc.) fluid flow through the valve assembly 200. As indicated by the arrows in FIGS. 3 and 4, the check valve 202 prevents, restricts, or at least inhibits fluid flow therethrough when closed (FIG. 3) but allows fluid flow therethrough when open (FIG. 4).

Various components of the flow control valve assembly 200 may be identical or similar to the corresponding components of the flow control valve assembly 100 shown in FIG. 1 and described above. For example, the valve assembly 200 may include a valve housing or body 204, valve ports or openings 212, a plug or cover 220, a check valve chamber 222, a control valve 230, diaphragm 231, and coil spring 233 identical or similar in structure and/or operation to the corresponding housing or body 104, valve ports or openings 112, a plug or cover 120, a check valve chamber 122, a control valve 130, diaphragm 131, and coil spring 133 of the valve assembly 100. But the check valve 202 may also be used in other valve assemblies, such as valve assemblies configured differently (e.g., with flux-coated solder rings on the inside and outside of the plug, etc.) and/or with different components than the flow control valve assemblies 100 and 200.

With further regard to the plug 220 that is used to seal or closes off the valve port or opening 212 and check valve chamber 222, this exemplary embodiment includes a flux-coated solder ring 260 installed or disposed along or on an outer surface of the plug 220. Accordingly, this exemplary embodiment does not include any solder ring or liquid flux applied to the inside of the plug 220. As noted above, the inventors hereof have discovered that excess flux from having a flux-coated solder ring on the inside of the plug may cause a check valve member to stick or adhere to a plug when the check valve is open. Accordingly, the inventors' elimination of a flux-coated solder ring on the inside of the plug 220 helps to eliminate or at least reduce problems associated with excess flux.

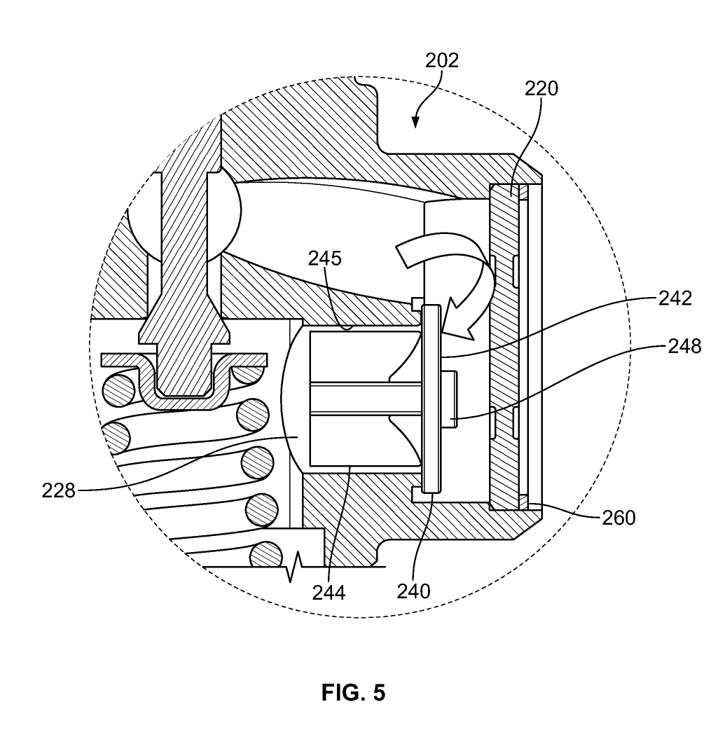

The check valve 202 includes a check valve member 240 movable between a closed position (shown in FIGS. 3 and 5) and an open position (FIG. 4). In the closed position, the valve member 240 sealingly engages or blocks the valve opening or passageway 228, such that the valve member 240 prevents, restricts, or at least inhibits fluid flow, e.g., in a forward or inlet-to-outlet direction, from the check valve chamber 222 to the valve opening 228. From the closed position, the valve member 240 is movable away from the valve seat 241 to the open position. In the open position, the valve member 240 is spaced apart from the valve seat 241 (FIG. 4) such that fluid flow, e.g., in a reverse or outlet-to-inlet direction, is permitted from the valve opening 228 to the check valve chamber 222.

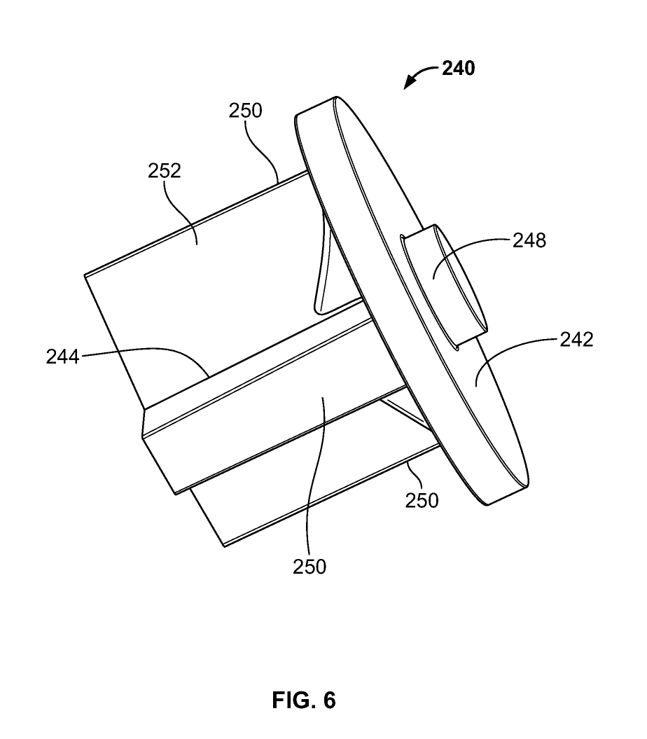

With reference to FIGS. 5 and 6, the check valve member 240 comprises a first or sealing member 242 and at least one second or guide member 244 extending outwardly from the first member 242. The first member 242 is configured to contact the valve seat 241 and seal or close the valve opening 228 when in the closed position. The at least one second member 244 is configured to be disposed within the opening or passageway 228 (e.g., defined by inner wall 245 or internal bore, etc.), such that at least one second member 244 rides or slides within or along the internal bore. Contact between the inner wall 245 and the at least one second member 244 may help guide the sliding movement of the check valve member 240 between its open and closed positions. With the valve member being configured to ride or slide in the internal bore of the check valve instead of a trepan, the inventors' exemplary embodiment thus allow elimination of the trepan.

In this illustrated embodiment, the first member 242 comprises a generally circular plate. The at least one second member 244 comprises a stem or portion extending outwardly from the first member or plate 242. The stem 244 includes three legs or portions respectively defining three sliding contact surfaces 250 (FIG. 6) spaced apart from each other and inwardly spaced from a perimeter edge of the plate 242. A recessed portion or gap 252 is between each adjacent pair of surfaces 250. These recessed portions 252 (e.g., concave or triangular shaped portions, etc.) reduce the amount of surface area contact between the check valve 240 and inner wall 245 (FIG. 5) that might otherwise occur without these recessed portions 252. This is because when the check valve 240 is moved between the open and closed positions, the check valve 240 contacts the inner wall 245 only along one or more of the sliding contact surfaces 250, which have a smaller surface area due to the recessed portions 252. In some embodiments, the check valve member 240 may be configured (e.g., sized, shaped, etc.) such that only one of the three surfaces will contact the inner wall 245 when the valve member 240 is slidably moving. By reducing the surface area contact between the inner wall 245 and the check valve 240, this configuration of the check valve member 240 helps improve lubricity and/or helps reduce stiction.

Also in this exemplary embodiment, the valve member 240 includes a central projection 248 (broadly, a stop) extending outwardly from an outer surface of the first member or plate 242. In operation, the central projection 248 may contact the inner surface of the plug 220 to restrict further movement of the valve member 240 towards the plug 220 as the valve member 240 is moving into the open position. Accordingly, the central projection 248 thus reduces the amount of surface area contact that might otherwise occur when the check valve 240 is the open position, as the plug 220 only makes contact with the smaller surface area of the central projection 248 and not the entire first member or plate 242. By reducing the surface area contact between the plug 220 and the check valve 240, the central projection 248 helps eliminate or reduce problems associated with stiction and sticking or adhering of the check valve 240 to the plug 220.

In this exemplary embodiment, the check valve member 240 is injection molded from PEEK or PEEK filled with PTFE (e.g., PEEK with 20 percent PTFE loading, etc.). The injection molded PEEK valve member 240 may provide better lubricity for the valve member being moved as compared to a conventional stamped metal valve member and/or eliminate problems associated with burrs that may sometimes occur with a conventional stamped metal valve member. In alternative embodiments, a check valve may be formed from different materials (e.g., other metal or non-metals, etc.) and/or manufacturing processes (e.g., stamping, other molding processes besides injection molding, etc.). For example, an alternative embodiment may include a check valve member that is injection molded from a different material than PEEK, etc. and/or that does not include a central projection.

The plate 242, leg or stem 244, and central projection 248 of the valve member 240 may be configured to cooperatively provide the check valve member 240 with a generally mushroom shape. In alternative embodiments, the check valve 240 may have a different configuration (e.g., different shape, more than one integral leg, one or more non-integral legs attached to the plate, etc.).

In exemplary embodiments, a valve may include a seating surface or a mating surface (e.g., of a movable valve member, etc.) that is selectively engageable with the seating surface for opening and closing the valve. In such exemplary embodiments, at least one of or both of the seating surface and the mating surface may comprise PEEK filled with PTFE (e.g., PEEK with 20 percent PTFE loading, etc.). The use of PEEK/PTFE composites may allow improvements for anti-stiction purposes, aiding sealing capacity, and/or provide the benefits of the PTFE migrating (to a greater percentage) to the surface during molding. By way of example, the valve may be used with or as an expansion valve for a refrigeration system or air conditioning system.

Exemplary embodiments disclosed herein may be used in various applications and/or in various valve assemblies. By way of example only, an exemplary embodiment of a check valve may be used in an expansion valve for a refrigeration system or an air conditioning system.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A valve assembly comprising:
a valve housing including a check valve chamber and an opening;
a check valve for controlling fluid flow relative to the check valve chamber;
a plug sealingly engaged within the opening, to thereby seal the check valve chamber and restrict fluid flow from the check valve chamber out the opening through the valve housing; and
a flux-coated solder ring along an outer surface of the plug, without any flux-coated solder ring along an inner surface of the plug.

2. The valve assembly of claim 1, wherein the check valve includes a valve member comprising polyether ether ketone and movable relative to a valve opening for opening and closing the valve opening.

3. The valve assembly of claim 1, wherein the check valve includes an injection molded polyether ether ketone valve member movable relative to a valve opening for opening and closing the valve opening.

4. The valve assembly of claim 1, wherein:
the check valve includes a valve member movable relative to a valve opening for opening and closing a valve opening;
the valve member comprises a plate and a stop extending outwardly from the plate in a direction towards the plug; and
the stop is configured to contact the plug to thereby restrict further movement of the valve member towards the plug beyond an open position and inhibit contact of the plate with the plug, whereby surface area contact between the valve member and plug is reduced.

5. The valve assembly of claim 4, wherein:
a valve seat defines the valve opening;
the stop comprise a central projection; and
the valve member is movable between:
a closed position in which the plate seats against the valve seat to sealingly engage and close the valve opening; and
an open position in which the central projection contacts the plug and the plate is spaced apart from the valve seat such that fluid flow is permitted through the valve opening.

6. The valve assembly of claim 4, wherein:
the valve member includes a portion extending outwardly from the plate in a direction opposite of the stop;
the portion is configured to be slidably disposed within the valve opening; and
the portion includes at least one sliding surface spaced inwardly from a perimeter edge of the plate, for contacting an inner wall of the valve opening for guiding sliding movement of the valve member between open and closed positions relative to the valve opening.

7. The valve assembly of claim 1, wherein:
the check valve includes a valve member movable relative to a valve opening for opening and closing a valve opening;
the valve member includes a portion configured to be slidably disposed within the valve opening; and
the portion includes a plurality of spaced-apart sliding surfaces and a recessed portion between adjacent pairs of the spaced-apart sliding surfaces, whereby surface area contact between the portion of the valve member and an inner wall of the valve opening is reduced.

8. The valve assembly of claim 1, wherein:
the check valve includes a valve member movable relative to a valve opening for opening and closing the valve opening; and
the valve member includes a central projection extending outwardly in a direction towards the plug to thereby restrict further movement of the valve member towards the plug beyond an open position and limits further contact of the valve member with the plug.

9. The valve assembly of claim 1, further comprising:
an inlet;
an outlet;
a first valve opening between the inlet and the outlet;
a second valve opening between the outlet and the check valve chamber;
a passageway between the inlet and the check valve chamber; and
a control valve element movable relative to the first valve opening for opening and closing the first valve opening;
wherein the check valve includes a valve member movable relative to the second valve opening between an open position in which fluid flow is permitted through the second valve opening and a closed position in which the valve member restricts fluid flow through the second valve opening.

10. A expansion valve including the valve assembly of claim 9.

11. A check valve comprising:
a plate sealingly engageable with a valve opening;
a central projection extending outwardly from the plate, and configured for contacting an external component to inhibit contact of the plate with the external component to thereby reduce surface area contact between the check valve and the external component;
a portion extending outwardly from the plate in a direction opposite of the central projection, the portion configured to be slidably disposed within the valve opening, whereby the plate is slidably movable between open and closed positions relative to the valve opening.

12. The check valve of claim 11, wherein the portion includes a plurality of spaced-apart sliding surfaces and a recessed portion between adjacent pairs of the spaced-apart sliding surfaces, whereby surface area contact between the portion and an inner wall of the valve opening is reduced.

13. The check valve of claim 11, wherein the plate, the central projection, and the portion of the check valve comprise polyether ether ketone.

14. The check valve of claim 11, wherein the plate, the central projection, and the portion of the check valve comprise injection molded polyether ether ketone.

15. A valve assembly including the check valve of claim 11, further comprising:
a valve housing including a check valve chamber and an opening through a side of the valve housing;
a plug sealingly engaged within the opening through the side of the valve housing, to thereby seal the check valve chamber and restrict fluid flow from the check valve chamber out the opening through the valve housing;
a flux-coated solder ring along an outer surface of the plug, without any flux-coated solder ring along an inner surface of the plug;
wherein a valve seat defines the valve opening; and
wherein the plate is seats against the valve seat in the closed position; and
wherein the central projection contacts the plug and the plate is spaced apart from the valve seat such that fluid flow is permitted through the valve opening in the open position.

16. The valve assembly of claim 15, further comprising:
an inlet;
an outlet;
a first valve opening between the inlet and the outlet;
a second valve opening between the outlet and the check valve chamber;
a passageway between the inlet and the check valve chamber; and
a control valve element movable relative to the first valve opening for opening and closing the first valve opening.

17. A valve assembly comprising:
a valve housing including a check valve chamber;
an inlet;
an outlet;
a first valve opening between the inlet and the outlet;
a second valve opening between the outlet and the check valve chamber;
a control valve element movable relative to the first valve opening for opening and closing the first valve opening; and
a check valve member comprising injection molded polyether ether ketone and movable relative to the second valve opening between an open position in which fluid flow is permitted through the second valve opening and a closed position in which the check valve member restricts fluid flow through the second valve opening.

18. The valve assembly of claim 17, wherein the check valve member comprises:
a plate sealingly engageable with the second valve opening;
a central projection extending outwardly from the plate, and configured for contacting an external component to inhibit contact of the plate with the external component to thereby reduce surface area contact between the check valve member and the external component; and
a portion extending outwardly from the plate in a direction opposite of the central projection, the portion configured to be slidably disposed within the second valve opening such that the check valve member is slidably movable between open and closed positions in a direction generally perpendicular relative to the second valve opening.

19. The valve assembly of claim 18, wherein the portion includes a plurality of spaced-apart sliding surfaces and a recessed portion between adjacent pairs of the spaced-apart sliding surfaces, whereby surface area contact between the portion and an inner wall of the valve opening is reduced.

20. The valve assembly of claim 17, wherein:
the valve housing includes an opening through a side of the valve housing;
a plug is sealingly engaged within the opening through the side of the valve housing, to thereby seal the check valve chamber and restrict fluid flow from the check valve chamber out the opening through the valve housing; and
a flux-coated solder ring is along an outer surface of the plug, without any flux-coated solder ring along an inner surface of the plug;
a valve seat defines the second valve opening;
the plate seats against the valve seat in the closed position; and
the central projection contacts the plug and the plate is spaced apart from the valve seat such that fluid flow is permitted through the valve opening in the open position.
